(19) United States
(12) Patent Application Publication
(10) Pub. No.: US 2018/0066100 A1
(43) Pub. Date: Mar. 8, 2018

(54) ISOCYANATE-BASED TEMPERATURE-RESISTANT FOAMS WITH HIGH FLAME RESISTANCE

(71) Applicants: BASF SE, Ludwigshafen (DE); Covestro Deutschland AG, Leverkusen (DE)

(72) Inventors: Sindhu MENON, Osnabrück (DE); Roland KRÄMER, Mannheim (DE); Jürgen BOOS, Nordhorn (DE); Florian HUPKA, Düsseldorf (DE); Torsten HAGEN, Essen (DE)

(21) Appl. No.: 15/551,779

(22) PCT Filed: Feb. 17, 2016
(86) PCT No.: PCT/EP2016/053371

§ 371 Date: Aug. 17, 2017

(30) Foreign Application Priority Data
Feb. 20, 2015 (EP) 15155888.9

(51) Int. Cl. C08G 18/18; C08G 18/00; C08G 18/76; C08J 9/00; C08J 9/02; C08J 9/12; C08J 9/14

(52) U.S. Cl. CPC C08G 18/1816; C08G 18/1825; C08G 18/1833; C08G 18/003; C08G 18/7664; C08G 2101/005; C08J 9/02; C08J 9/12; C08J 9/142; C08J 9/149; C08J 9/0028

(57) ABSTRACT

The invention relates to temperature-resistant foams with a high degree of flame resistance, to the production of same from aromatic isocyanates and polyepoxides using incorporable catalysts and with formic acid as a blowing agent, and to the use of said foams.

The present invention relates to a process for producing a foam in which a) a polyisocyanate is mixed with b) at least one organic compound having at least two epoxy groups, c) at least one catalyst accelerating the isocyanate/epoxide reaction, d) chemical and/or physical blowing agents containing formic acid, and e) optionally auxiliary agents and additives, to form a reaction mixture, wherein the equivalent ratio of isocyanate groups to epoxy groups is from 1.2:1 to 500:1, and the reaction mixture is reacted into a foam, wherein said catalyst accelerating the isocyanate/epoxide reaction includes at least one catalyst selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, di-methyl-2-(2-aminoethoxyethanol) and (1,3-bis(dimethylamino)-propane-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl ether), 3-dimethylaminoisopropyl-diisopropanolamine, or mixtures thereof, and to foams obtainable by such process, and to the use of these foams as a filling foam in the construction field or as a core foam of sandwich constructs, or for producing construction materials or insulating materials.

In early studies, U.S. Pat. No. 3,793,236, U.S. Pat. No. 4,129,695 and U.S. Pat. No. 3,242,108 describe the preparation of foams from polyisocyanates and polyepoxides. In part, like in U.S. Pat. No. 3,849,349, the addition of further H-active substances is described.

The more recent prior art describes the preferred preparation of such foams from reaction mixtures of organic polyisocyanates and organic polyepoxides via an intermediate containing partially trimerized isocyanurate groups (=intermediate), which is stabilized by means of stoppers. In this case, the high-temperature resistant foams are obtained by reacting reaction mixtures of organic polyisocyanates, organic polyepoxides, catalysts and stoppers to form a storage-stable higher viscosity intermediate (“pretrimerization”), and reacting this higher viscosity intermediate by the addition of blowing agents and a catalyst spontaneously accelerating the isocyanate/epoxide reaction into the final foamed end state, which is no longer meltable.

The preparation of storage-stable isocyanate/epoxide mixtures with the addition of an inhibitor having an alkylating effect as a stopper is at first described in EP 0 331 996 and EP 0 272 563. The preparation of an EPIC foam (epoxide/isocyanate) from an intermediate admixed with sulfonic acid alkyl esters having an alkylating effect as stoppers is disclosed in DE 39 38 062 A1. It is described that any organic polyisocyanates may be employed as the isocyanate component, especially polyisocyanate mixtures of the diphenylmethane series. In addition to the 2,4′-isomers, one among several other polyisocyanate components mentioned as being preferred may contain other isomeric or homologous polyisocyanates of the diphenylmethane series, and from 10 up to 60% by weight of higher nuclear polyphenyl polymethylene polyisocyanates, based on the total mixture of polyisocyanates.

According to WO 2012/80185 A1 and WO 2012/150201 A1, the quality of the thus prepared foams can be critically improved if certain blowing agents are used for the preparation of the EPIC foams. According to the teaching from these documents, the preparation of the EPIC foam is also preferably effected through the reaction of the starting materials in the presence of a stabilizer acting as a stopper. The polyisocyanate component employed as being preferred is generally either mixtures of 2,4′-MDI with 4,4′-MDI and optionally from 0 to 20% by weight of 2,2′-MDI, based on the total mixture, or mixtures of these isomers with higher nuclear polymeric MDI (pMDI), the latter generally being present in the mixtures at from 10% by weight to 60% by weight, based on the total mixture of polyisocyanates. In the Examples, mixtures of isomeric monomer MDI types are used.

The foams containing reaction products of the EPIC reaction and having high temperature resistance as described in the prior art are already known for their good mechanical properties and their high temperature stability. They also already have a reduced flammability as compared to that of polyurethane foams. However, The production method going through the two-stage process is quite complicated. In addition, it is necessary to anneal the foams to achieve the good mechanical properties. Finally, the mechanical properties and especially the fire behavior of the foams with and especially without the addition of flame retardants should be further improved.

Therefore, it has been the object of the present invention to provide a foam having high temperature resistance based on isocyanates and organic polyepoxides that is readily and quickly prepared, has excellent mechanical properties, and shows a low flammability.

The object of the invention was achieved by a foam obtainable by a process in which a) a polyisocyanate is mixed with b) at least one organic compound having at least two epoxy groups, c) at least one catalyst accelerating the isocyanate/epoxide reaction, d) chemical and/or physical blowing agents containing formic acid, and e) optionally auxiliary agents and additives, to form a reaction mixture, wherein the equivalent ratio of isocyanate groups to epoxy groups is from 1.2:1 to 500:1, and the reaction mixture is reacted into a foam, wherein said catalyst accelerating the isocyanate/epoxide reaction includes at least one catalyst selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and (1,3-bis(dimethylamino)propane-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl ether), 3-dimethylaminoisopropyl-diisopropanolamine, or mixtures thereof.

The invention also relates to the use of the foamable mixtures before the end of the foaming to form the foam having high temperature resistance according to the invention for adhesively bonding substrates, for adhesively bonding steel, aluminum and copper plates, plastic sheets, and polybutylene terephthalate sheets.

The “polyisocyanate (a)” according to the present invention means an organic compound containing at least two reactive isocyanate groups per molecule, i.e., its functionality is at least 2. If the polyisocyanates employed or a mixture of several polyisocyanates has no unitary functionality, the number average functionality of the component a) employed is at least 2. Preferably, the average isocyanate functionality of the polyisocyanates a) is at least 2.2 and more preferably at least 2.4. The average functionality of component a) is from 2.2 to 4, preferably from 2.5 to 3.8, and more preferably from 2.7 to 3.5.

Preferably, the content of isocyanate groups in component a) is from 5 to 10 mmol/g, especially from 6 to 9 mmol/g, more preferably from 7 to 8.5 mmol/g. The skilled person is aware of the fact that the content of isocyanate groups in mmol/g and the so-called equivalent weight in g/equivalent are in a reciprocal mutual relationship. The content of isocyanate groups in mmol/g is obtained from the content in % by weight according to ASTM D-5155-96 A.

The viscosity of component a) employed may vary within a wide range. Preferably, component a) has a viscosity at 25° C. according to DIN 53 018 of from 100 to 10,000 mPa·s, more preferably from 200 to 2500 mPa·s.

Polyisocyanates a) that may be considered include the per se known aliphatic, cycloaliphatic, araliphatic and preferably aromatic polyvalent isocyanates. Such multifunctional isocyanates are per se known or can be prepared by per se known methods. In particular, the multifunctional isocyanates may also be employed as mixtures, so that component a) contains different multifunctional isocyanates in such a case. Multifunctional isocyanates that may be used as the polyisocyanate have two (hereinafter referred to as diisocyanates) or more than two isocyanate groups per molecule.

In detail, there may be mentioned, in particular: alkylene diisocyanates with 4 to 12 Carbon atoms in the alkylene radical, such as 1,12-dodecane diisocyanate, 2-ethyltetramethylene diisocyanate 1,4,2-methylpentamethylene diisocyanate-1,5, tetramethylene diisocyanate-1,4, and preferably hexamethylene diisocyanate-1,6; cycloaliphatic diisocyanates, such as cyclohexane-1,3 and -1,4 diisocyanates, and any mixtures of such isomers, 1-isocyanato-3,3,5-trimethyl-5-isocyanatomethylcyclohexane (IPDI), 2,4- and 2,6-hexahydrotoluene diisocyanate, and the corresponding mixtures of isomers, 4,4′-, 2,2′- and 2,4′-dicyclohexylmethane diisocyanate, and the corresponding mixtures of isomers, and preferably aromatic polyisocyanates, such as 2,4- and 2,6-toluene diisocyanate the corresponding mixtures of isomers, 4,4′-, 2,4′- and 2,2′-diphenylmethane diisocyanate the corresponding mixtures of isomers, mixtures of 4,4′- and 2,2′-diphenylmethane diisocyanates, polyphenyl polymethylene polyisocyanates, mixtures of 4,4′-, 2,4′- and 2,2′-diphenylmethane diisocyanates and polyphenyl polymethylene polyisocyanates (raw MDI) and mixtures of raw MDI and toluene diisocyanates.

Particularly suitable are 2,2′-, 2,4′- and/or 4,4′-diphenylmethane diisocyanate (MDI), 1,5-naphthylene diisocyanate (NDI), 2,4- and/or 2,6-toluene diisocyanate (TDI), 3,3′-dimethyldiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene-1,5 diisocyanate, 2-ethylbutylene-1,4 diisocyanate, pentamethylene-1,5 diisocyanate, butylene-1,4 diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and 4,4′-, 2,4′- and/or 2,2′-dicyclohexylmethane diisocyanate.

Modified polyisocyanates, i.e., products obtained by the chemical reaction of organic polyisocyanates and having at least two reactive isocyanate groups per molecule, are also often used. In particular, there may be mentioned polyisocyanates containing ester, urea, biuret, allophanate, carbodiimide, isocyanurate, uretdione, carbamate and/or urethane groups, often also together with unreacted polyisocyanates.

More preferably, the polyisocyanates of component a) contain 2,2′-MDI or 2,4′-MDI or 4,4′-MDI, or oligomeric MDI, which consists of higher nuclear homologues of MDI containing at least 3 aromatic nuclei and a functionality of at least 3, or mixtures of two or three of the above mentioned diphenylmethane diisocyanates, or raw MDI, which is obtained during the preparation of MDI, or preferably mixtures of at least one oligomer of MDI and at least one of the above mentioned low molecular weight MDI derivatives 2,2′-MDI, 2,4′-MDI or 4,4′-MDI (also referred to as polymeric MDI). Usually, the isomers and homologues of MDI are obtained by distilling raw MDI.

Preferably, polymeric MDI contains one or more polynuclear condensation products of MDI having a functionality of more than 2, especially 3 or 4 or 5, in addition to dinuclear MDI. Polymeric MDI is known and is often referred to as polyphenyl polymethylene polyisocyanate.

The (average) functionality of a polyisocanate containing polymeric MDI may vary within a range of from about 2.2 to about 4, especially from 2.5 to 3.8, and more particularly from 2.7 to 3.5. Such a mixture of MDI-based multifunctional isocyanates having different functionalities include, in particular, raw MDI, which is obtained as an intermediate product during the preparation of MDI.

Multifunctional isocyanates or mixtures of several multifunctional isocyanates based on MDI are known and are sold, for example, by the BASF Polyurethanes GmbH under the designation of Lupranat® M20 or Lupranat® M50.

Preferably, component (a) contains at least 70, more preferably at least 90, and especially 100% by weight, based on the total weight of component (a), one or more isocyanates selected from the group consisting of 2,2′-MDI, 2,4′-MDI, 4,4′-MDI and oligomers of MDI. The content of oligomeric MDI is preferably at least 50% by weight, more preferably more than 60% by weight, and especially at least 64% by weight, based on the total weight of component (a).

Component b), which contains epoxy groups, is any aliphatic, cycloaliphatic, aromatic and/or heterocyclic compounds having at least two epoxy groups. The preferred epoxides that are suitable as component b) have 2 to 4, preferably 2, epoxy groups per molecule, and an epoxy equivalent weight of from 90 to 500 g/eq, preferably from 140 to 220 g/eq.

Suitable polyepoxides include, for example, polyglycidyl ethers of polyvalent phenols, for example, of pyrocatechol, resorcinol, hydroquinone, 4,4′-dihydroxydiphenylpropane (bisphenol A), of 4,4′-dihydroxy-3,3′-dimethyldiphenylmethane, of 4,4′-dihydroxydiphenylmethane (bisphenol F), 4,4′-dihydroxydiphenylcyclohexane, of 4,4′-dihydroxy-3,3′-dimethyldiphenylpropane, of 4,4′-dihydroxydiphenyl, from 4,4′-dihydroxydiphenylsulfone (bisphenol S), of tris(4-hydroxyphenyl)methane, the chlorination and bromination products of the above mentioned diphenols, of novolacs (i.e., from reaction products of mono- or polyvalent phenols and/or cresols with aldehydes, especially formaldehyde, in the presence of acidic catalysts at an equivalent ratio of less than 1:1), of diphenols obtained by the esterification of 2 mole of the sodium salt of an aromatic oxycarboxylic acid with one mole of a dihaloalkane or dihalodialkyl ester (cf. British Patent 1 017 612) or of polyphenols obtained by the condensation of phenols and long-chained haloparaffins containing at least two halogen atoms (cf. GB-PS 1 024 288). Further, there may be mentioned: Polyepoxy compounds based on aromatic amines and epichlorohydrin, N-di(2,3-epoxypropyl)aniline, N,N′-dimethyl-N,N′-diepoxypropyl-4,4′-diaminodiphenylmethane, N,N-diepoxypropyl-4-aminophenyl glycidyl ether (cf. GB-PS 772 830 and 816 923).

In addition, there may be used: glycidyl esters of polyvalent aromatic, aliphatic and cycloaliphatic carboxylic acids, for example, phthalic acid diglycidyl ester, isophthalic acid diglycidyl ester, terephthalic acid diglycidyl ester, adipic acid diglycidyl ester, and glycidyl esters of reaction products of 1 mole of an aromatic or cycloaliphatic dicarboxylic acid anhydride and ½ mole of a diol, or 1/n mole of a polyol with n hydroxy groups, or hexahydrophthalic acid diglycidyl ester, which may optionally be substituted with methyl groups.

Glycidyl ethers of polyvalent alcohols, for example, of 1,4-butanediol (Araldite® DY-D, Huntsman), 1,4-butenediol, glycerol, trimethylolpropane (Araldite® DY-T/CH, Huntsman), pentaerythritol and polyethylene glycol, may also be used. Of further interest are triglycidyl isocyanurate, N,N′-diepoxypropyloxyamide, polyglycidyl thioether of polyvalent thiols, such as from bismercaptomethylbenzene, diglycidyltrimethylenetrisulfone, polyglycidyl ether based on hydantoins.

Finally, epoxidation products of polyunsaturated compounds, such as vegetable oils and their conversion products, may also be employed. Epoxidation products of di- and polyolefins, such as butadiene, vinylcyclohexane, 1,5-cyclooctadiene, 1,5,9-cyclododecatriene, polymers and mixed polymers that still contain epoxidizable double bonds, e.g., based on polybutadiene, polyisoprene, butadiene-styrene mixed polymers, divinylbenzene, dicyclopentadiene, unsaturated polyesters, further epoxidation products of olefins that are accessible by Diels-Alder addition and are subsequently converted to polyepoxides by epoxidation with a per compound, or from compounds that contain two cyclopentene or cyclohexene rings linked through bridging atoms or bridge head atom groups, may also be used.

In addition, polymers of unsaturated monoepoxides may also be employed, for example, of methacrylic acid glycidyl ester or allyl glycidyl ether.

Preferably, the following polyepoxy compounds of mixtures thereof are used as component b) according to the invention:

Polyglycidyl ethers of polyvalent phenols, especially of bisphenol A (Araldit® GY250, Huntsman; Ruetapox® 0162, Bakelite AG; Epikote® Resin 162, Hexion Specialty Chemicals GmbH; Eurepox 710, Brenntag GmbH; Araldit® GY250, Huntsman, D.E.R.™ 332, The Dow Chemical Company; Epilox® A 18-00, LEUNA-Harze GmbH) or bisphenol F (4,4′-dihydroxydiphenylmethane, Araldit® GY281, Huntsman; Epilox® F 16-01, LEUNA-Harze GmbH; Epilox® F 17-00, LEUNA-Harze GmbH) polyepoxy compounds based on aromatic amines, especially bis(N-epoxypropyl)aniline, N,N′-dimethyl-N,N′-diepoxypropyl-4,4′-diaminodiphenylmethane and N,N-diepoxypropyl-4-aminophenylglycidylether; polyglycidyl ester of cycloaliphatic dicarboxylic acids, especially hexahydrophthalic acid diglycidyl ester and polyepoxides from the conversion product of n moles hexahydrophthalic acid anhydride and 1 mole of a polyol with n hydroxy groups (n=integer of 2-6), especially 3 mole of hexahydrophthalic anhydride, and one mole of 1,1,1-trimethylolpropane; 3,4-epoxycyclohexylmethane-3,4-epoxycyclohexane carboxylate.

Polyglycidyl ethers of bisphenol A and bisphenol F as well as of novolacs are more particularly preferred, especially the polyglycidyl ether of bisphenol F.

Liquid polyepoxides or low viscosity diepoxides, such as bis(N-epoxypropyl)aniline or vinylcyclohexane diepoxide, may further reduce the viscosity of already liquid polyepoxides in particular cases, or convert solid polyepoxides to liquid mixtures.

Component b) is employed in an amount that corresponds to an equivalent ratio of isocyanate groups to epoxy groups of from 1.2:1 to 500:1, preferably from 3:1 to 65:1, especially from 3:1 to 30:1, more preferably from 3:1 to 15:1.

Catalysts c) strongly accelerate the reaction of the organic compound (b) having epoxy groups with the organic, optionally modified polyisocyanates (a). The catalysts (c) include at least one amine catalyst that can be incorporated and is selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and (1,3-bis(dimethylamino)-propane-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl ether), 3-dimethylaminoisopropyl-diisopropanoamine, or mixtures thereof.

In addition to the amine catalysts that can be incorporated, other usual amine catalysts as are also known for the preparation of polyurethanes may also be employed. For example, there may be mentioned amidines, such as 2,3-dimethyl-3,4,5,6-tetrahydropyrimidine, tertiary amines, such as triethylamine, tributylamine, triethylenediamine, dimethylcyclohexylamine, dimethyloctylamine, N,N-dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(N,N-dimethylaminoethyl) ether, bis(dimethylaminopropyl)urea, dimethylpiperazine, 1,2-dimethylimidazole, 1-azabicyclo[3.3.0]octane, and preferably 1,4-diazabicyclo[2.2.2]octane. Also suitable are, for example, pentamethyldiethylene triamine, N-methyl-N′-dimethylaminoethylpiperazine, N,N-diethylethanolamine and silamorpholine, boron trichloride tert. amine adducts, and N-[3-(dimethylamino)propyl]formamide.

If other catalysts are employed in addition to catalysts that can be incorporated, they preferably contain boron trichloride tert. amine adducts, N,N-dimethylbenzylamine and/or N,N-methyldibenzylamine and/or borontrichloro(N,N-dimethyloctylamine).

Catalysts (c) are preferably employed at a concentration of from 0.001 to 8% by weight, more preferably from 0.6 to 6% by weight, further preferably from 1.5 to 5% by weight, and especially from 2.1 to 5% by weight, as a catalyst or combination of catalysts, based on the total weight of components (a), (b) and (c). The proportion of catalyst with isocyanate-reactive groups is at least 5% by weight, more preferably at least 8% by weight, and especially from 8 to 25% by weight, based on catalyst (c).

The chemical and/or physical blowing agents (d) that are used for producing the foams according to the invention contain formic acid, optionally in admixture with further blowing agents. In addition to formic acid and optionally water, phospholine oxide may be used as a chemical blowing agent. These chemical blowing agents react with isocyanate groups to form carbon dioxide, or carbon dioxide and carbon monoxide in the case of formic acid. Since these blowing agents release the gas by a chemical reaction with the isocyanate groups, they are referred to as chemical blowing agents. In addition, physical blowing agents, such as low boiling hydrocarbons, may be employed. Particularly suitable are liquids that are inert towards the polyisocyanates a), and have boiling points below 100° C., preferably below 50° C., under atmospheric pressure, so that they will evaporate under the influence of the exothermic polyaddition reaction. Examples of such liquids that are preferably used include alkanes, such as heptane, hexane, n- and iso-pentane, preferably technical mixtures of n- and iso-pentanes, n- and iso-butane, and propane, cycloalkanes, such as cyclopentane and/or cyclohexane, ethers, such as furan, dimethyl ether and diethyl ether, ketones, such as acetone and methyl ethyl ketone, carboxylic acid alkyl esters, such as methyl formiate, dimethyl oxalate, and ethyl acetate, and halogenated hydrocarbons, such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane, pentafluoropropane, heptafluoropropane, and hexafluorobutene. Mixtures of these low-boiling liquids with one another and/or with other substituted or unsubstituted hydrocarbons may also be used. Further suitable are organic carboxylic acids, such as formic acid, acetic acid, oxalic acid, ricinoleic acid, and compounds containing carboxy groups. Preferably, the physical blowing agents are soluble in component (b).

Preferably, less than 2% by weight, more preferably less than 1% by weight, more preferably less than 0.5% by weight, and especially no, halogenated hydrocarbons are used as said blowing agent (d). The weight proportions each relate to the total weight of components (a) to (e). Preferably, water, formic acid/water mixtures, or formic acid are used as chemical blowing agents, more preferred chemical blowing agents include formic acid/water mixtures, or formic acid. Preferably, pentane isomers or mixtures of pentane isomers are used as physical blowing agents.

The chemical blowing agents may be used alone, i.e., without the addition of physical blowing agents, or together with physical blowing agents. Preferably, the chemical blowing agents are used alone. If chemical blowing agents are used together with physical blowing agents, preferably pure water, formic acid/water mixtures or pure formic acid are employed together with pentane isomers or mixtures of pentane isomers. In a particularly preferred embodiment, formic acid is the sole blowing agent.

As said auxiliary agents and additives (e), there may be employed, for example, multifunctional compounds containing hydroxy or amino groups e1), which include e1-i) compounds having at least 2, especially from 2 to 8, and preferably from 2 to 3, alcoholic hydroxy groups and a molecular weight of from 62 to 8000 g/mol. Such compounds are per se known as structural components of polyurethane, and include low molecular weight chain extenders and polyols with number average molecular weights of more than 200 g/mol. Examples of chain extenders include simple polyhydric alcohols, such as ethylene glycol, hexanediol-1,6, glycerol or trimethylolpropane, examples of polyols include polyols having dimethylsiloxane moieties, for example, bis(dimethylhydroxymethylsilyl) ether; polyhydroxy compounds having ester groups, such as castor oil or polyhydroxy polyester, as accessible by the polycondensation of superfluous amounts of simple polyvalent alcohols of the kind just mentioned in an exemplary way with, preferably dibasic, carboxylic ac ids or anhydrides thereof, such as adipic acid, phthalic acid, or phthalic anhydride, polyhydroxy polyethers as accessible by an addition reaction of alkylene oxides, such as propylene oxide and/or ethylene oxide with suitable starter molecules, such as water, the simple alcohols just mentioned above, or even amines having at least two aminic NH linkages, or polycarbonate polyols, which may be obtained, for example, from polyhydric alcohols and carbonates or phosgene.

In addition, the compounds e1) may also be e1-ii) compounds with at least two isocyanate-reactive hydrogen atoms, of which at least one belongs to a primary or secondary amino group. These include polyetheramines and compounds with molecular weights of less than 500 g/mol and two amino groups. Polyetheramines are known from polyurethane chemistry and can be obtained by terminal amination of polyether polyols. These preferably have molecular weights of from 500 to 8000 g/mol. The preferably used compounds with two amino groups and having molecular weights of smaller than 500 g/mol more preferably have a molecular weight of 58 to 300 g/mol, especially from 100 to 200 g/mol. These compounds preferably have two primary amino groups as said isocyanate-reactive groups. In a particularly preferred embodiment, the primary amino groups are linked to aromatic hydrocarbons, preferably to an aromatic six-ring, especially in meta- or para-position. In particular, diethylenetoluenediamine (DETDA), especially DETDA 80, is employed as said compounds e1-ii). Diethylenetoluenediamine is commercially available, for example, from Lonza or Albemarle.

If compounds with two amino groups and molecular weights of less than 500 g/mol are employed, it is preferably done in amounts of from 0.1 to 5, more preferably from 0.5 to 2% by weight, based on the total weight of compounds (a) and (b).

If any, the additives e1) are included in a maximum amount that corresponds to an NCO/OH equivalent ratio of at least 2:1, preferably at least 7:1, and especially at least 10:1, based on the isocyanate groups of component a) and the hydroxy groups and/or amino groups of component e1). At any rate, the amount of component a) must be such that the equivalent ratio of isocyanate groups of component a) to the sum of the epoxy groups of component b), hydroxy groups and/or amino groups of component e1) and the hydroxy groups that may be present in component b) is at least 1.2:1, preferably from 3:1 to 65:1, especially from 3:1 to 30:1, more preferably from 3:1. to 15:1.

The ratio of the weight of all compounds containing hydroxy and/or urea groups from component e1), preferably of polyols and polyetheramines, to the weight of epoxy component b) is preferably smaller than 30:70, preferably it is at most 28:72, more preferably at most 25:75, and even more preferably from 0-20:80-100.

The EPIC foam according to the invention preferably contains urethane groups and/or urea groups derived from the reaction of the polyisocyanate a) with component (e) at a small weight proportion. The content of urethane groups and/or urea groups resulting from the reaction of polyisocyanate a) with the hydroxy and/or urea groups from component e) is preferably below 6% by weight, preferably below 5% by weight, more preferably below 4% by weight, and even more preferably below 3% by weight, based on the total weight of the components. In one embodiment, the EPIC foam does not contain any urethane groups and/or urea groups resulting from the reaction of the polyisocyanate a) with component e).

Preferably, the reaction mixture contains less than 28% by weight, more preferably less than 25% by weight, of compounds containing hydroxy groups and/or amino groups of component e1), based on the total weight of components b) and e1), and the EPIC foam contains less than 6% by weight, preferably less than 5% by weight, of urethane and/or urea groups derived from the reaction of polyisocyanate a) with component e), based on the total weight of the foam.

More preferably, the reaction mixture contains less than 28% by weight, preferably less than 25% by weight, of polyols and/or polyether amines, based on the total weight of components b) and polyols and/or polyetheramines, and the EPIC foam contains less than 6% by weight, preferably less than 5% by weight, of urethane and/or urea groups derived from the reaction of polyisocyanate a) with component e), based on the total weight of the foam.

Further auxiliary agents and additives e2) that may optionally be included are polymerizable olefinically unsaturated monomers, which may be employed in amounts of up to 100% by weight, preferably up to 50% by weight, especially up to 30% by weight, based on the total weight of components a) and b). Typical examples of additives e2) include olefinically unsaturated monomers having no hydrogen atoms that are reactive towards NCO groups, such as diisobutylene, styrene, C₁-C₄-alkylstyrenes, such as α-methylstyrene, α-butylstyrene, vinyl chloride, vinyl acetate, maleic imide derivatives, such as bis(4-maleinimidophenyl)methane, acrylic acid C₁-C₈-alkyl ester, such as acrylic acid methyl ester, acrylic acid butyl ester, or acrylic acid octyl ester, the corresponding methacrylic acid esters, acrylonitrile, or diallyl phthalate. Any mixtures of such olefinically unsaturated monomers may also be employed. Preferably, styrene and/or (meth)acrylic acid C₁-C₄-alkyl ester is used, provided that the additives e2) are employed at all.

If additives e2) are included, the inclusion of classical polymerization initiators, such as benzoyl peroxide, is possible, but generally not required.

The inclusion of auxiliary agents and additives e1) or e2) is generally not required. Incidentally, the additives mentioned by way of example under e1-i) and especially under e1-ii) are preferred over the compounds mentioned by way of example under e2). In principle, it is also possible to include all three kinds of auxiliary agents and additives at the same time.

Further auxiliary agents and additives e) that may optionally be included are, for example, e3) fillers, such as quartz flour, chalk, microdol, alumina, silicon carbide, graphite or corundum; pigments such as titanium dioxide, iron oxide or organic pigments, such as phthalocyanine pigments; plasticizers, such as dioctyl phthalate, tributyl or triphenyl phosphate; compatibilizers that can be incorporated, such as methacrylic acid, β-hydroxypropyl ester, maleic acid and fumaric acid esters; substances improving flame retardancy, such as red phosphorus or magnesium oxide; soluble dyes or reinforcing materials, such as glass fibers or glass tissues. Also suitable are carbon fibers or carbon fiber tissues, and other organic Polymer fibers, such as aramide fibers or LC polymer fibers (LC=“Liquid Crystal”). Further, metallic fillers may be considered as fillers, such as aluminum, copper, iron and/or steel. In particular, the metallic fillers are employed in a granular form and/or in powder form.

Further auxiliary agents and additives e) that may optionally be included are, for example, e4) olefinically unsaturated monomers with hydrogen atoms that are reactive towards NCO groups, such as hydroxyethyl methacrylate, hydroxypropyl methacrylate, and aminoethyl methacrylate.

In addition, the auxiliary agents and additives e) may contain e5) known foam stabilizers of the polyethersiloxane type, mold-release agents, e.g., polyamide waxes and/or stearic acid derivatives, and/or natural waxes, e.g., carnauba wax.

The auxiliary agents and additives e) may be either incorporated in the starting materials a) and b) before the process according to the invention is performed, or admixed with them later.

Preferably, the auxiliary agents and additives e) are included only in such a maximum amount that the NCO/OH equivalent ratio, based on the isocyanate groups of component a) and the hydroxy groups and/or amino groups of component e), is 2:1, preferably at least 7:1, and more preferably at least 10:1.

For performing the process according to the invention, the starting materials a) and b) can be mixed with one another. Then, optionally further auxiliary agents and additives e), the catalyst c) and blowing agents d) are added to the reaction mixture, all is thoroughly mixed, and the foamable mixture is cast into an open or closed mold.

When a multicomponent mixing head as known from polyurethane processing is used, the process is characterized by a high flexibility. By varying the mixing ratio of components a) and b), different foam qualities can be prepared with identical starting materials. In addition, different components a) and different components b) may also be supplied to the mixing head at different ratios. The auxiliary agents and additives e), the catalyst c) and blowing agents d) may be supplied to the mixing head separately or as a batch. It is also possible to meter the auxiliary agents and additives e) together with the catalyst c), and to separately meter the blowing agents d). Foams with different bulk density ranges can be prepared by varying the amount of blowing agent.

Preferably, the mixing of the components is effected in one stage (so-called “one-shot” method). More preferably, the reaction should be performed without the step of preliminary trimerization. The preparation process can be performed continuously or discontinuously.

Depending on the components employed, the blowing process generally starts after a waiting time of 2 s to 4 min and is usually completed after 2 min to 8 min. The foams are fine-celled and uniform.

A subsequent temperature treatment of the foams according to the invention is not required. In the preferred embodiment, the foams are not annealed.

In another embodiment, a subsequent temperature treatment at from 70 to 250° C., preferably from 120 to 250° C., more preferably from 180 to 220° C., is performed after the foaming into the final foamed state.

When a closed mold is used for preparing the foams according to the invention (mold foaming), it may be advantageous to overfill the mold in order to achieve optimum properties. “Overfilling” means that an amount of foamable mixture is filled in that would occupy a larger volume than the inner volume of the mold amounts to in an open mold after the foaming is complete.

The foams according to the invention have a low thermal conductivity, very good mechanical properties, such as a high compressive strength, and a high modulus of elasticity in compression. Further, the foams according to the invention are hardly flammable and generate little heat and smoke upon combustion. They have low dielectric losses, the moisture resistance and abrasion resistance as well as the processability in molds are excellent. Therefore, the foams according to the invention are excellently suitable as filling foams for hollow spaces, as filling foams for electric insulation, as a core of sandwich constructions, for the preparation of construction materials for all kinds of interior and exterior applications, for the preparation of construction materials for vehicle, ship, airplane and rocket construction, for the preparation of airplane interior and exterior construction parts, for the preparation of all kinds of insulation materials, for the preparation of insulation plates, tube and container insulations, for the preparation of sound-absorbing materials, for use in engine compartments, for the preparation of grinding wheels, and for the preparation of high-temperature insulations and hardly flammable insulations.

The invention will be further explained by means of the following Examples.

### EXAMPLES

In the following Examples, all percentages are by weight.

Unless explicitly stated otherwise, all quantities and measured values relate to foams prepared without subsequent storage at elevated temperature (annealing).

The measurement of the compressive strengths was effected according to ISO 844 EN.

The measurement of the bulk densities was effected according to DIN EN ISO 845.

The thermal conductivity was determined according to DIN 52612-2 at a temperature of 10° C.

The measurement of the maximum average rate of heat emission (MARHE) was effected according to ISO 5660-1. The measurement of the total smoke production per occupied surface (TSP) was effected according to ISO 5660-2. All tests were performed with a radiant heat flux density of 50 kW/m² on test specimens having dimensions of 100 mm×100 mm×20 mm.

The flammability and flame spread were determined according to the requirements of building material class B2 according to DIN 4102-1.

The setting time is defined as the period between the beginning of stirring and the time when no more adhesive effect can be observed when the foam surface is touched with a rod.

All Examples according to the invention were prepared with a total amount of starting materials of 500±10 g. The foams were foamed in cardboard cups with volumes of 10 liters.

The following starting materials were used:

Isocyanates:

A0: Mixture of 60% by weight 2,4′-diisocyanatodiphenylmethane and 40% by weight 4,4′-diisocyanatodiphenylmethane.

A1: Mixture of about 40% by weight monomeric MDI and about 60% by weight oligomeric MDI, average functionality about 2.7, isocyanate content of 31.5 g/100 g according to ASTM D 5199-96 A and a viscosity at 25° C. of 210 mPa·s according to DIN 53 018.

A2: Mixture of about 30% by weight monomeric MDI and 70% by weight oligomeric MDI, functionality of about 2.8, isocyanate content of 31.5 g/100 g according to ASTM D 5199-96 A, viscosity at 25° C. of 550 mPa·s according to DIN 53 018.

A3: Mixture of about 25% by weight monomeric MDI and 75% by weight oligomeric MDI, average functionality of about 2.9, isocyanate content of 31 g/100 g according to ASTM D 5199-96 A, viscosity at 25° C. of 2200 mPa·s according to DIN 53 018.

A4: For the preparation of A4, A2 was charged, and the lowest boiling components, the isomers of diisocyanatodiphenylmethane, were evaporated by means of a short-path evaporator with a surface area of 0.06 m² under a pressure of 0.05 mbar and an oil bath temperature of 175° C. Under such conditions, the mass balance showed that 25 to 27% by weight of the supplied amount was evaporated.

The thus obtained bottoms product A4 was analyzed by means of HPLC, in which an average molecular weight of 527 g/mol and a polydispersity of 1.7 were determined. Further, a content of monomeric MDI of 12% by weight was determined. The viscosity of the product obtained was determined with a plate-plate rheometer with diameters of the plate of 25 mm, and it was 8000 mPa·s at a temperature of 25° C. The distillation product was employed without further purification steps.

A5: Mixture of about 35% by weight monomeric MDI and 65% by weight polymeric MDI, functionality of about f=3.19, isocyanate content of 30.5 to 32%, viscosity at 25° C. from 610 to 750 mPa·s according to DIN 53 019.

Epoxides:

B0: Diglycidyl ether of bisphenol A, Ruetapox 0162, commercial product of Bakelite AG; Duisburg/Germany, epoxide index: 5.8-6.1 eq/kg and an epoxy equivalent of 167-171 g/eq, viscosity at 25° C. is 4000 to 5000 mPas.

B1: diglycidylether of bisphenol A, commercial product D.E.R.™ 332 von The Dow Chemical Company, USA, epoxy equivalent of 171-175 g/eq according to ASTM D-1652, viscosity at 25° C. is 4000 to 6000 mPa·s according to ASTM D-445.

B2: Leuna Epilox® A 18-00, low molecular weight epoxy resin based on bisphenol A, commercial product of LEUNA-Harze GmbH, Leuna/Germany, epoxy equivalent of 175-185 g/eq according to DIN 16 945, viscosity at 25° C. from 8000 to 10,000 mPa·s according to DIN 53 015.

B3: Leuna Epilox® F 16-01, low molecular weight epoxy resin based on bisphenol F, commercial product of LEUNA-Harze GmbH, Leuna/Germany, epoxy equivalent of 157-167 g/eq according to DIN 16 945, viscosity at 25° C. from 1200 to 1600 mPa·s according to DIN 53 015.

B4: Leuna Epilox® F 17-00, low molecular weight epoxy resin based on bisphenol F, commercial product of LEUNA-Harze GmbH, Leuna/Germany, epoxy equivalent of 165-173 g/eq according to DIN 16 945, viscosity at 25° C. from 2500 to 4500 mPa·s according to DIN 53 015.

C Catalysts

C0 Addocat 3144: N-[3-(dimethylamino)propyl]formamide, commercial product of Rheinchemie, Mannheim/Germany

C1 Accelerator DY 9577: boron trichloride-amine complex, thermolatent catalyst, commercial product of Huntsman, Bad Sackingen, Germany

C2 N,N-Methyldibenzylamine, CAS No. 102-05-06, obtainable from Sigma-Aldrich/Germany

C3 N,N-Dimethylbenzylamine, 98% CAS No. 103-83-3, obtainable from Sigma-Aldrich/Germany

C4 Dabco-T: N,N,N′-trimethylaminoethylethanolamine, commercial product of Air Products and Chemicals, Allentown Pa., USA

C5 Jeffcat ZF-10: N,N,N-trimethyl-N-hydroxyethylbis(aminoethyl ether), commercial product of Huntsman, Bad Sackingen, Germany

C6 Jeffcat ZR-50: N,N-bis(3-dimethylaminopropyl)-N-isopropanolamine, commercial product of Huntsman, Bad Sackingen, Germany

C7 Lupragen N 101: 2-dimethylaminoethanol, commercial product of BASF SE, Ludwigshafen, Germany

C8 Lupragen N 107: dimethyl-2-(2-aminoethoxy)ethanol, commercial product of BASF SE, Ludwigshafen, Germany

C9 Dabco TMR-30: 2,4,6-tri(dimethylaminomethyl)phenol catalyst from the company Air Products

Blowing Agents

D0 Formic acid (98-100%), CAS No. 64-18-6, obtainable from KMF Laborchemie, Lohmar/Germany

D1 85% by weight formic acid CAS No. 64-18-6 in water

D2 Water

D3 Solkane 365/227: liquid hydrofluorocarbon as a blowing agent for foams, mixture of pentafluorobutane (87% by weight) with heptafluoropropane (13% by weight), obtainable from Solvay Fluor GmbH, Hannover, Germany

D4 Enovate® 3000: liquid hydrofluorocarbon pentafluoropropane as a blowing agent for foams, obtainable from Honeywell International Inc., Buffalo, USA

D5 Cyclopentane, CAS No. 287-92-3

D6 Formacel® 1100: liquid hydrofluorocarbon hexafluorobutene as a blowing agent for foams, obtainable from DuPont de Nemours (Germany) GmbH, Neu Isenburg, Germany

D7 Solkane R 141b: 1,1-dichloro-1-fluoroethane

E Additives

E1 p-Toluenesulfonic acid methyl ester: CAS No. 80-48-8, obtainable from Merck KGaA Darmstadt/Germany

E2 Desmophen 3600Z: polyether polyol, OH number 56 mg KOH/g, f=2, prepared by propoxylation of 1,2-propylene glycol: commercial product of Bayer MaterialScience, Leverkusen, Germany

E3 Tegostab B 8411: polyether polysiloxane, commercial product of Evonik, Essen, Germany

E4 Tegostab B 8485: polyether polysiloxane, commercial product of Evonik, Essen, Germany

E5 DETDA 80, diethyltoluenediamine, CAS No. 68479-98-1, obtainable from Lonza, Basel, Switzerland

E6 Dabco DC 193, silicone surfactant from the company Air Products

### Example 1

(Comparison, EPIC Reaction Resin Preparation, Preliminary Trimerization to Intermediate)

At 50° C., 800 g of isocyanate A0 was mixed with 200 g of epoxide B0 and 0.1 ml of C3, followed by heating at 120° C. The slightly exothermic reaction indicated the immediate start of the isocyanurate formation. After a reaction time of 2 hours without external heating, the charge was cooled. This resulted in an interior temperature of about 90° C. A sample was taken from the charge. The sample has an NCO content of 23% NCO. The reaction was quenched by adding 1.07 g of E1. Subsequently, the charge was stirred at 120° C. for another 30 min. A clear yellow storage-stable resin that is liquid at 20° C. and has a viscosity at 25° C. of 2080 mPa·s and an NCO content of 21.4% (intermediate) was formed.

### Example 2a

### Comparison

By means of a quick stirrer, 400 g of the resin from Example 1 was loaded with air for 2 minutes. With stirring, 17.6 g of E2, 7.0 g of E3 and 3.5 g of C0 are added. Immediately thereafter, 6.0 g of D0 was added, and the reaction mixture was thoroughly mixed for another 10 s. The reaction mixture was cast into a cardboard box having dimensions of 20 cm×20 cm×24 cm, and the reaction mixture was allowed to foam in said cardboard box. The foam was annealed at 200° C. for 3 hours.

The bulk density of the thus obtained foam was 39 kg/m³, the compressive strength was 0.246 N/mm². The foam meets the requirements of building material class B2 according to DIN 4102-1. The foam had a MARHE value of 120 kW/m² and a total smoke production of 920 m²/m².

### Example 2b

### Comparison

By means of a quick stirrer, 400 g of the resin from Example 1 was loaded with air for 2 minutes. With stirring, 17.6 g of E2, 7.0 g of E3 and 3.5 g of C0 are added. Immediately thereafter, 6.0 g of DO was added, and the reaction mixture was thoroughly mixed for another 10 s. The reaction mixture was cast into a cardboard box having dimensions of 20×20×24 cm, and the reaction mixture was allowed to foam in said cardboard box.

The bulk density of the thus obtained foam was 39 kg/m³, the compressive strength was 0.296 N/mm². The foam does not meet the requirements of building material class B2 according to DIN 4102-1. The foam had a MARHE value of 132 kW/m² and a total smoke production of 761 m²/m².

### Example 3

The isocyanate and the epoxy resin were mixed together by means of a quick stirrer at 1000 rpm for 20 s to 30 s. The chemical blowing agent was added and mixed in at 1000 rpm for 10 s. Physical blowing agents were then added and mixed in at 200 rpm until a homogeneous mixture was obtained. Thereafter, catalysts were added and mixed in at 2000 rpm for 3 s.

The exact composition of the starting substances and the mechanical values and the results of the fire test of the foams obtained are stated in Table 1.

TABLE 1
Components in foam formulation and physical characteristics.
All amounts stated in % by weight.

| | | | | |
|---|---|---|---|---|
| Formulation | 3.1 | 3.2 | 3.3 | 3.4 |
| Isocyanate | A1 | A2 | A3 | A4 |
| Isocyanate amount | 68.2 | 68.16 | 68.51 | 68.16 |
| Epoxy resin | B1 | B1 | B1 | B1 |
| Epoxy resin amount | 17.65 | 17.65 | 17.45 | 17.65 |
| Catalyst C1 | 1.02 | 1.02 | 1.01 | 1.02 |
| Catalyst C2 | 0.73 | 0.73 | 0.73 | 0.73 |
| Catalyst C3 | 0.49 | 0.49 | 0.48 | 0.49 |
| Catalyst C4 | 0.64 | 0.64 | 0.63 | 0.64 |
| Blowing agent D1 | 0.99 | 0.99 | 0.98 | 0.99 |
| Blowing agent D3 | 7.06 | 7.06 | 6.98 | 7.06 |
| Additive E4 | 1.93 | 1.93 | 1.91 | 1.93 |
| Additive E5 | 1.34 | 1.34 | 1.33 | 1.34 |
| Measured values | | | | |
| Compressive strength | 0.157 | 0.192 | 0.187 | 0.138 |
| (N mm⁻²) | | | | |
| Bulk density (kg m⁻³) | 32 | 34 | 35 | 37 |
| Thermal conductivity | 21.5 | 20.4 | 20.7 | 20.2 |
| (mW m⁻¹ K⁻¹) | | | | |
| Meets DIN 4102-1 B2 | Yes | Yes | Yes | Yes |
| MARHE (kW m⁻²) | 77 | 72 | 72 | 68 |
| TSP (m² m⁻²) | 477 | 386 | 818 | 443 |

### Example 4

According to the foaming method as described in Example 3, foams based on the epoxy component B4 were prepared. The exact composition of the starting substances and the mechanical values and the results of the fire test are stated in Table 2.

TABLE 2
Components in foam formulation and physical characteristics.
All amounts of the formulation stated in % by weight.

| | | | | |
|---|---|---|---|---|
| Formulation | 4.1 | 4.2 | 4.3 | 4.4 |
| Isocyanate | A1 | A3 | A2 | A5 |
| Isocyanate amount | 68.15 | 68.15 | 68.15 | 68.15 |
| Epoxy resin | B4 | B4 | B4 | B4 |
| Epoxy resin amount | 17.65 | 17.65 | 17.65 | 17.65 |
| Catalyst C1 | 1.02 | 1.02 | 1.02 | 1.02 |
| Catalyst C2 | 0.73 | 0.73 | 0.73 | 0.73 |
| Catalyst C3 | 0.49 | 0.49 | 0.49 | 0.49 |
| Catalyst C4 | 0.64 | 0.64 | 0.64 | 0.64 |
| Blowing agent D1 | 0.99 | 0.99 | 0.99 | 0.99 |
| Blowing agent D3 | 7.06 | 7.06 | 7.06 | 7.06 |
| Additive E4 | 1.93 | 1.93 | 1.93 | 1.93 |
| Additive E5 | 1.34 | 1.34 | 1.34 | 1.34 |
| Measured values | | | | |
| Compressive strength | 0.12 | 0.12 | 0.12 | 0.16 |
| (N mm⁻²) | | | | |
| Bulk density (kg m⁻³) | 26 | 29 | 29 | 34 |
| Thermal conductivity | 21.9 | 22.3 | 21.6 | 21.7 |
| (mW m⁻¹ K⁻¹) | | | | |
| Meets DIN 4102-1 B2 | Yes | Yes | Yes | Yes |
| MARHE (kW m⁻²) | 69 | 68 | 81 | 66 |
| TSP (m² m⁻²) | 250 | 250 | 375 | 386 |

### Example 5

According to the foaming method as described in Example 3, foams were prepared, in which the blowing agent was varied. In Examples V5.7 and V5.8, no catalyst that can be incorporated was employed. In Example V5.9, a catalyst with a little reactive, aromatic OH group was employed. The exact composition of the starting substances and the mechanical values and the results of the fire test are stated in Table 3.

TABLE 3
Components in foam formulation and physical characteristics. All amounts of the
formulation stated in % by weight.

| | Formulation | | | | | | | | |
|---|---|---|---|---|---|---|---|---|---|
| | 5.1 | 5.2 | 5.3 | 5.4 | 5.5 | 5.6 | V5.7 | V5.8 | V5.9 |
| Isocyanate | A2 | A2 | A2 | A2 | A2 | A2 | A2 | A2 | A2 |
| Isocyanate amount | 68.15 | 68.15 | 68.15 | 68.15 | 68.15 | 68.15 | 68.15 | 68.15 | 68.15 |
| Epoxy resin | B2 | B2 | B2 | B2 | B2 | B2 | B2 | B2 | B2 |
| Epoxy resin amount | 22.62 | 17.61 | 19.47 | 22.49 | 20.00 | 19.47 | 23.2 | 20.4 | 17.0 |
| Catalyst C1 | 1.30 | 1.01 | 1.12 | 1.30 | 1.15 | 1.12 | 1.34 | 1.18 | |
| Catalyst C2 | 0.94 | 0.73 | 0.81 | 0.94 | 0.83 | 0.81 | 0.96 | 0.85 | |
| Catalyst C3 | 0.62 | 0.49 | 0.54 | 0.62 | 0.55 | 0.54 | 0.64 | 0.56 | |
| Catalyst C4 | 0.81 | 0.63 | 0.70 | 0.81 | 0.72 | 0.70 | 0 | 0 | |
| Catalyst C9 | | | | | | | | | 4.4 |
| Blowing agent D1 | 0 | 0 | 0 | 1.53 | 0 | 0 | 0 | 0 | 0.6 |
| Blowing agent D2 | 1.36 | 1.06 | 0.93 | 0 | 0.88 | 0.93 | 1.4 | 0.9 | |
| Blowing agent D4 | 0 | 7.05 | 4.67 | 0 | 0 | 0 | 0 | 0 | |
| Blowing agent D5 | 0 | 0 | 0 | 0 | 4.00 | 0 | 0 | 4.2 | |
| Blowing agent D6 | 0 | 0 | 0 | 0 | 0 | 4.67 | 0 | 0 | |
| Blowing agent D7 | | | | | | | | | 8.0 |
| Additive E4 | 2.47 | 1.92 | 2.13 | 2.46 | 2.18 | 2.13 | 2.53 | 2.23 | |
| Additive E5 | 1.72 | 1.34 | 1.48 | 1.71 | 1.52 | 1.48 | 1.76 | 1.55 | |
| Additive E6 | | | | | | | | | 1.9 |
| Measured values | | | | | | | | | |
| Compressive | 0.131 | 0.129 | 0.198 | 0.198 | 0.137 | 0.184 | 0.141 | 0.139 | |
| strength (N mm⁻²) | | | | | | | | | |
| Bulk density | 28.1 | 24.4 | 32.6 | 36.4 | 25.2 | 35 | 27.9 | 26.6 | 42.4 |
| (kg m⁻³) | | | | | | | | | |
| Thermal | 23.3 | 21.8 | 27.2 | 24.2 | 20.6 | 20.6 | 23.1 | 21.4 | |
| conductivity | | | | | | | | | |
| (mW m⁻¹ K⁻¹) | | | | | | | | | |
| Meets DIN 4102-1 | Yes | Yes | Yes | Yes | Yes | Yes | Yes | Yes | Yes |
| B2 | | | | | | | | | |
| MARHE (kW m⁻²) | 75 | 67 | 64 | 74 | 73 | 72 | 93 | 89 | 125 |
| TSP (m² m⁻²) | 591 | 318 | 409 | 568 | 330 | 420 | 591 | 352 | |

The Examples in Table 3 show that the fire properties can be significantly improved by the use of catalysts that can be incorporated according to the invention, while the mechanical properties are otherwise similar. In particular, the MARHE values are clearly reduced for the foams according to the invention.

### Example 6

According to the foaming method as described in Example 3, foams were prepared, in which exclusively reactive catalysts were used in Examples 6.1 to 6.5.

In comparison, when a catalyst package with non-reactive components (6.6) is used, the setting time of the foam becomes extremely long. Thus, the foam remains adhesive over a very long time and is characterized by too low a strength after foaming, which is very disadvantageous for the processing.

TABLE 4
Components in foam formulation and physical characteristics. All amounts of the
formulation stated in % by weight.

| | Formulation | | | | | |
|---|---|---|---|---|---|---|
| | 6.1 | 6.2 | 6.3 | 6.4 | 6.5 | 6.6 |
| Isocyanate | A2 | A2 | A2 | A2 | A2 | A2 |
| Isocyanate amount | 68.15 | 68.15 | 68.15 | 68.15 | 68.15 | 68.15 |
| Epoxy resin | B2 | B2 | B2 | B2 | B2 | B2 |
| Epoxy resin amount | 19.89 | 19.89 | 19.89 | 19.89 | 19.89 | 20.0 |
| Catalyst C4 | 0.72 | 0 | 0 | 0 | 0 | 0 |
| Catalyst C5 | 0 | 0.72 | 0 | 0 | 0 | 0 |
| Catalyst C6 | 0 | 0 | 0.72 | 0 | 0 | 0 |
| Catalyst C7 | 0 | 0 | 0 | 0.72 | 0 | 0 |
| Catalyst C8 | 0 | 0 | 0 | 0 | 0.72 | 0 |
| Catalyst C1 | 0 | 0 | 0 | 0 | 0 | 0.27 |
| Catalyst C2 | 0 | 0 | 0 | 0 | 0 | 0.14 |
| Catalyst C3 | 0 | 0 | 0 | 0 | 0 | 0.10 |
| Blowing agent D1 | 1.11 | 1.11 | 1.11 | 1.11 | 1.11 | 0.96 |
| Blowing agent D3 | 7.96 | 7.96 | 7.96 | 7.96 | 7.96 | 8.0 |
| Additive E4 | 2.17 | 2.17 | 2.17 | 2.17 | 2.17 | 2.18 |
| Additive E5 | 0 | 0 | 0 | 0 | 0 | 0.21 |
| Measured values | | | | | | |
| Setting time (s) | 94 | 285 | 230 | 260 | 118 | >600 s |
| Compressive strength | 0.152 | 0.143 | 0.139 | 0.164 | 0.146 | 0.17 |
| (N mm⁻²) | | | | | | |
| Bulk density (kg m⁻³) | 28.8 | 29.6 | 29.2 | 30 | 28.9 | 34 |
| Thermal conductivity | 21.4 | 23.4 | 22.4 | 22.9 | 21.8 | 23.4 |
| (mW m⁻¹ K⁻¹) | | | | | | |
| Meets DIN 4102-1 B2 | Yes | Yes | Yes | Yes | Yes | Yes |
| MARHE (kW m⁻²) | 90 | 92 | 88 | 85 | 89 | 85 |
| TSP (m² m⁻²) | 375 | 420 | 443 | 375 | 750 | 409 |

1.-13. (canceled)

14. A process for producing a foam in which
a) a polyisocyanate is mixed with
b) at least one organic compound having at least two epoxy groups,
c) at least one catalyst accelerating the isocyanate/epoxide reaction,
d) chemical and/or physical blowing agents containing formic acid, and
e) optionally auxiliary agents and additives,
to form a reaction mixture, wherein the equivalent ratio of isocyanate groups to epoxy groups is from 1.2:1 to 500:1, and the reaction mixture is reacted into a foam, wherein said catalyst (c) accelerating the isocyanate/epoxide reaction includes at least one catalyst selected from the group consisting of bisdimethylaminopropylurea, bis(N,N-dimethylaminoethoxyethyl)carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol) and (1,3-bis(dimethylamino)propane-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl ether), 3-dimethylaminoisopropyl-diisopropanolamine, and mixtures thereof.

15. The process for producing a foam according to claim 14, wherein said isocyanates a) include 2,2′-MDI or 2,4′-MDI or 4,4′-MDI, or oligomeric MDI, or mixtures of two or three of said diphenylmethane diisocyanates 2,2′-MDI, 2,4′-MDI and 4,4′-MDI, or raw MDI, or mixtures of at least one oligomer of MDI and at least one of said low molecular weight MDI derivatives 2,2′-MDI, 2,4′-MDI or 4,4′-MDI.

16. The process for producing a foam according to claim 15, wherein said isocyanates a) include mixtures of at least one oligomer of MDI and at least one of said low molecular weight MDI derivatives 2,2′-MDI, 2,4′-MDI or 4,4′-MDI.

17. The process for producing a foam according to claim 16, wherein the content of said oligomeric MDI is greater than 60% by weight, based on the total weight of component (a).

18. The process for producing a foam according to claim 14, wherein said organic compounds having at least two epoxy groups are selected from the group consisting of a polyglycidyl ether of bisphenol A, bisphenol F, or novolacs, or mixtures thereof.

19. The process for producing a foam according to claim 14, wherein said catalyst accelerating the isocyanate/epoxide reaction (c) includes at least one further amine catalyst in addition to the catalyst having at least one isocyanate-reactive hydrogen atom.

20. The process for producing a foam according to claim 19, wherein said further amine catalyst is selected from the group consisting of boron trichloride tert. amine adducts, N,N-dimethylbenzylamine, N,N-methyldibenzylamine, and mixtures thereof.

21. The process for producing a foam according to claim 14, wherein said catalyst (c) is employed in an amount of from 2.1 to 5% by weight, based on the total weight of components (a), (b) and (c).

22. The process for producing a foam according to claim 14, wherein said blowing agents (d) do not contain any halogenated hydrocarbons.

23. The process for producing a foam according to claim 14, wherein said additive e) includes compounds e1-ii) with at least two isocyanate-reactive hydrogen atoms and a molecular weight of less than 500 g/mol, wherein at least one of said isocyanate-reactive hydrogen atoms belongs to a primary or secondary amino group.

24. A foam obtainable by a process according to claim 14.

25. A method comprising utilizing the foam according to claim 24 as a filling foam for hollow spaces, as a filling foam for electric insulation, as a core of sandwich constructions, for the preparation of construction materials for all kinds of interior and exterior applications, for the preparation of construction materials for vehicle, ship, airplane and rocket construction, for the preparation of airplane interior and exterior construction parts, for the preparation of all kinds of insulation materials, for the preparation of insulation plates, tube and container insulations, for the preparation of sound-absorbing materials, for use in engine compartments, for the preparation of grinding wheels, and for the preparation of high-temperature insulations and hardly flammable insulations.

26. A method comprising utilizing the foamable mixture according to claim 14 before the end of the foaming to form the foam having high temperature resistance according to the invention for adhesively bonding substrates, for adhesively bonding steel, aluminum and copper plates, plastic sheets, and polybutylene terephthalate sheets.
